(19) United States
(12) Patent Application Publication
(10) Pub. No.: US 2018/0117586 A1
(43) Pub. Date: May 3, 2018

(54) MODULAR ELECTROCHEMICAL AND/OR BIOASSAY SENSING PLATFORM AND CONTROL THEREOF

(71) Applicants: Danson Evan Lu Garcia, Toronto (CA); Jason Philip Ku, Toronto (CA); Hamed Mazhab Jafari, North York (CA)

(72) Inventors: Danson Evan Lu Garcia, Toronto (CA); Jason Philip Ku, Toronto (CA); Hamed Mazhab Jafari, North York (CA)

(21) Appl. No.: 15/341,009

(22) Filed: Nov. 2, 2016

(51) Int. Cl. B01L 3/00; G01N 27/27; B01L 7/00

(52) U.S. Cl. CPC B01L 3/502715; G01N 27/27; B01L 7/52; B01L 2300/0663; B01L 2300/023; B01L 2200/10; B01L 2300/0645; B01L 2300/024; B01L 2200/028

(57) ABSTRACT

A method includes implementing a modularized front-end of the sensing platform on a substrate, utilizing real estate on the substrate for a microfluidic and/or a nanofluidic chamber, providing a mixing enclosure of a sample on the substrate, providing an electrochemical cell and one or more other sensor(s) on the substrate. The method also includes controlling, through a microcontroller communicatively coupled to a memory, operational parameters of the microfluidic and/or the nanofluidic chamber, the electrochemical cell and the one or more other sensor(s), data acquisition therefrom and post-processing of the acquired data to enable configuration and monitoring thereof and visualization of the post-processed data, and performing electrochemical and/or bioassay sensing based on the control, the data acquisition and the post-processing of the acquired data.

### FIELD OF TECHNOLOGY

This disclosure relates generally to electrochemical and/or bioassay sensing and, more particularly, to a modular electrochemical and/or bioassay sensing platform and control thereof.

### BACKGROUND

Chemical and/or biological materials may be employed as samples in electrochemical and/or bioassay sensing processes. The applicability of microfluidics to said electrochemical and/or bioassay sensing processes may enhance capabilities thereof. A constituent operation (e.g., sample preparation) of a sensing process may be conducted at a particular physical location followed by another constituent operation (e.g., sample characterization) at another physical location. The human element in the transfer of a sample across different operations may result in contamination of the sample and error(s) in experimental results of the sensing process.

### SUMMARY

Disclosed are a method, a device and/or a system of a modular electrochemical and/or bioassay sensing platform and control thereof.

In one aspect, a method of a sensing platform includes implementing a modularized front-end of the sensing platform on a substrate, utilizing real estate on the substrate of the modularized front-end for a microfluidic and/or a nanofluidic chamber, providing a mixing enclosure of a sample on the substrate of the modularized front-end such that the microfluidic and/or the nanofluidic chamber interfaces therewith, and providing an electrochemical cell and one or more other sensor(s) on the substrate of the modularized front-end such that the microfluidic and/or the nanofluidic chamber interfaces with a corresponding space on the substrate including the electrochemical cell and the one or more other sensor(s). The sample includes a chemical material and/or a biological material. The one or more other sensor(s) is a temperature sensor and/or an alkalinity sensor.

The method also includes controlling, through a microcontroller communicatively coupled to a memory, operational parameters of the microfluidic and/or the nanofluidic chamber, the electrochemical cell and the one or more other sensor(s), data acquisition therefrom and post-processing of the acquired data to enable configuration and monitoring of the microfluidic and/or the nanofluidic chamber, the electrochemical cell and the one or more other sensor(s) and visualization of the post-processed data.

Further, the method includes performing, through the modularized front-end, electrochemical sensing and/or bioassay sensing of the sample based on the control of the operational parameters of the microfluidic and/or the nanofluidic chamber, the electrochemical cell and the one or more other sensor(s), the data acquisition therefrom and the post-processing of the acquired data through the microcontroller.

In another aspect, a sensing platform includes a modularized front-end implemented on a substrate and a microcontroller communicatively coupled to a memory. The modularized front-end includes a microfluidic and/or a nanofluidic chamber provided on real estate available on the substrate, and a mixing enclosure of a sample provided on the substrate such that the microfluidic and/or the nanofluidic chamber interfaces therewith. The sample includes a chemical material and/or a biological material. The modularized front-end also includes an electrochemical cell and one or more other sensor(s) provided on the substrate such that the microfluidic and/or the nanofluidic chamber interfaces with a corresponding: space on the substrate including the electrochemical cell and the one or more other sensor(s). The one or more other sensor(s) is a temperature sensor and/or an alkalinity sensor.

The microcontroller is configured to control operational parameters of the microfluidic and/or the nanofluidic chamber, the electrochemical cell and the one or more other sensor(s), data acquisition therefrom and post-processing of the acquired data to enable configuration and monitoring of the microfluidic and/or the nanofluidic chamber, the electrochemical cell and the one or more other sensor(s) and visualization of the post-processed data. The microcontroller is also configured to enable performing, through the modularized front-end, electrochemical sensing and/or bioassay sensing of the sample based on the control of the operational parameters of the microfluidic and/or the nanofluidic chamber, the electrochemical cell and the one or more other sensor(s), the data acquisition therefrom and the post-processing of the acquired data.

In yet another aspect, a sensing platform includes a modularized front-end implemented on a substrate and a data processing device communicatively coupled to the front-end of the sensing platform. The modularized front-end includes a microfluidic and/or a nanofluidic chamber provided on real estate available on the substrate, and a mixing enclosure of a sample provided on the substrate such that the microfluidic and/or the nanofluidic chamber interfaces therewith. The sample includes a chemical material and/or a biological material. The modularized front-end also includes an electrochemical cell and one or more other sensor(s) provided on the substrate such that the microfluidic and/or the nanofluidic chamber interfaces with a corresponding space on the substrate including the electrochemical cell and the one or more other sensor(s). The one or more other sensor(s) is a temperature sensor and/or an alkalinity sensor.

The data processing device is configured to control operational parameters of the microfluidic and/or the nanofluidic chamber, the electrochemical cell and the one or more other sensor(s), data acquisition therefrom and post-processing of the acquired data to enable configuration and monitoring of the microfluidic and/or the nanofluidic chamber, the electrochemical cell and the one or more other sensor(s) and visualization of the post-processed data. The data processing device is also configured to enable performing, through the modularized front-end, electrochemical sensing and/or bioassay sensing of the sample based on the control of the operational parameters of the microfluidic and/or the nanofluidic chamber, the electrochemical cell and the one or more other sensor(s), the data acquisition therefrom and the post-processing of the acquired data. The data processing device executes an application thereon to load one or more sensing parameter(s) of the operational parameters onto a component of the sensing platform.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a modular electrochemical and bioassay sensing platform, according to one or more embodiments.

FIG. 2 is a schematic view of a control and power management module of the modular electrochemical and bioassay sensing platform of FIG. 1, according to one or more embodiments.

FIG. 3 is an illustrative view of types of waveforms that can be generated through a function generator of the modular electrochemical and bioassay sensing platform of FIG. 1.

FIG. 4 is a schematic view of an example two-electrode configuration of an electrochemical cell formed by solely activating a counter electrode (CE) thereof.

FIG. 5 is a schematic view of an example three-electrode configuration of the electrochemical cell of FIG. 4 formed by activating both the CE and a reference electrode (RE) thereof.

FIG. 6 is a schematic view of a multi-channel amperometric measurement module of the modular electrochemical and bioassay sensing platform of FIG. 1 in the form of a device, according to one or more embodiments.

FIG. 7 is a schematic view of a multi-channel potentiometric measurement module of the modular electrochemical and bioassay sensing platform of FIG. 1 in the form of a device, according to one or more embodiments.

FIG. 8 is a schematic view of an impedance measurement module of the modular electrochemical and bioassay sensing platform of FIG. 1, according to one or more embodiments.

FIG. 9 is a schematic view of an alkalinity measurement module of the modular electrochemical and bioassay sensing platform of FIG. 1, according to one or more embodiments.

FIG. 10 is a schematic view of a microfluidic controller module of the modular electrochemical and bioassay sensing platform of FIG. 1, according to one or more embodiments.

FIG. 11 is a schematic view of an electrical lysis and polymerase chain reaction controller module of the modular electrochemical and bioassay sensing platform of FIG. 1 implemented as a control system, according to one or more embodiments.

FIG. 12 is a layout view of a front-end sensing module used in conjunction with all other modular components of the modular electrochemical and bioassay sensing platform of FIG. 1, according to one or more embodiments.

FIG. 13 is a schematic view of utility of an application interface of the modular electrochemical and bioassay sensing platform of FIG. 1 in an example scenario.

FIG. 14 is a schematic view of a configuration page that allows for customizability of sensing parameters by a user of the application interface of the modular electrochemical and bioassay sensing platform of FIG. 1 and a results page.

FIG. 15 is a schematic view of stages involved in operating the modular electrochemical and bioassay sensing platform of FIG. 1, according to one or more embodiments.

FIG. 16 is an illustrative view of an example visualization of results obtained through utilization of an electrochemical cell of the modular electrochemical and bioassay sensing platform of FIG. 1.

FIG. 17 is a schematic view of an alternate embodiment of the multi-channel amperometric measurement module of FIG. 6.

FIG. 18 is a schematic view of an alternate embodiment of the multi-channel potentiometric measurement module of FIG. 7.

FIG. 19 is a schematic view of a variation of the two-electrode configuration of the electrochemical cell of FIG. 4.

FIG. 20 is a schematic view of a variation of the three-electrode configuration of the electrochemical cell of FIG. 5.

FIG. 21 is a process flow diagram detailing the operations involved in realizing the modular electrochemical and bioassay sensing platform of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of a modular electrochemical and/or bioassay sensing platform and control thereof. Although the present embodiments have been described with reference to specific example embodiments, it will be evident that various modifications and changes may be made to these embodiments without departing from the broader spirit and scope of the various embodiments.

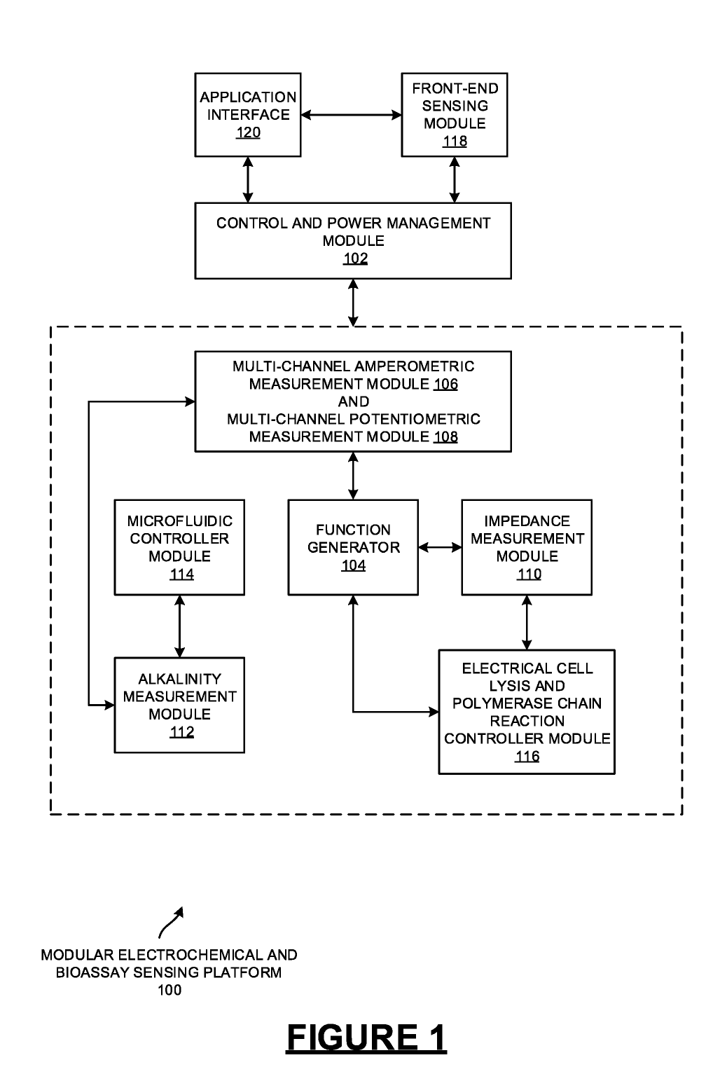

FIG. 1 shows a modular electrochemical and bioassay sensing platform 100, according to one or more embodiments. It should be noted that exemplary embodiments discussed herein are applicable to any form of chemical and/or biological sensing/assays. In one or more embodiments, modular electrochemical and bioassay sensing platform 100 may include a control and power management module 102 configured to monitor, communicate and power other modules thereof, a function generator 104 configured to generate specific waveforms for specific forms of analyses, a multi-channel amperometric measurement module 106 configured to measure electrochemically induced current signals (to be discussed below), and a multi-channel potentiometric measurement module 108 configured to measure electrochemically induced potential (voltage) signals (to be discussed below).

In one or more embodiments, modular electrochemical and bioassay sensing platform 100 may also include an impedance measurement module 110 configured to measure a total opposition of a substance/material to a flow of alternating current at a given frequency, an alkalinity measurement module 112 configured to determine an alkalinity of an aqueous solution (to be discussed below), a microfluidic controller module 114 equipped with high voltage control signals for activating micro-pumps and/or micro-valves, and an electrical cell lysis and polymerase chain reaction controller module 116 configured to break down cell membrane(s) and create thermal cycling.

In one or more embodiments, modular electrochemical and bioassay sensing platform 100 may further include a front-end sensing module 118 configured to be used as a bioassay sensor device (e.g., disposable device) interface and an application interface 120 (e.g., a mobile application, a computer application) to configure and visualize data. FIG. 1 shows the coupling between individual modules of modular electrochemical and bioassay sensing platform 100, according to one or more embodiments.

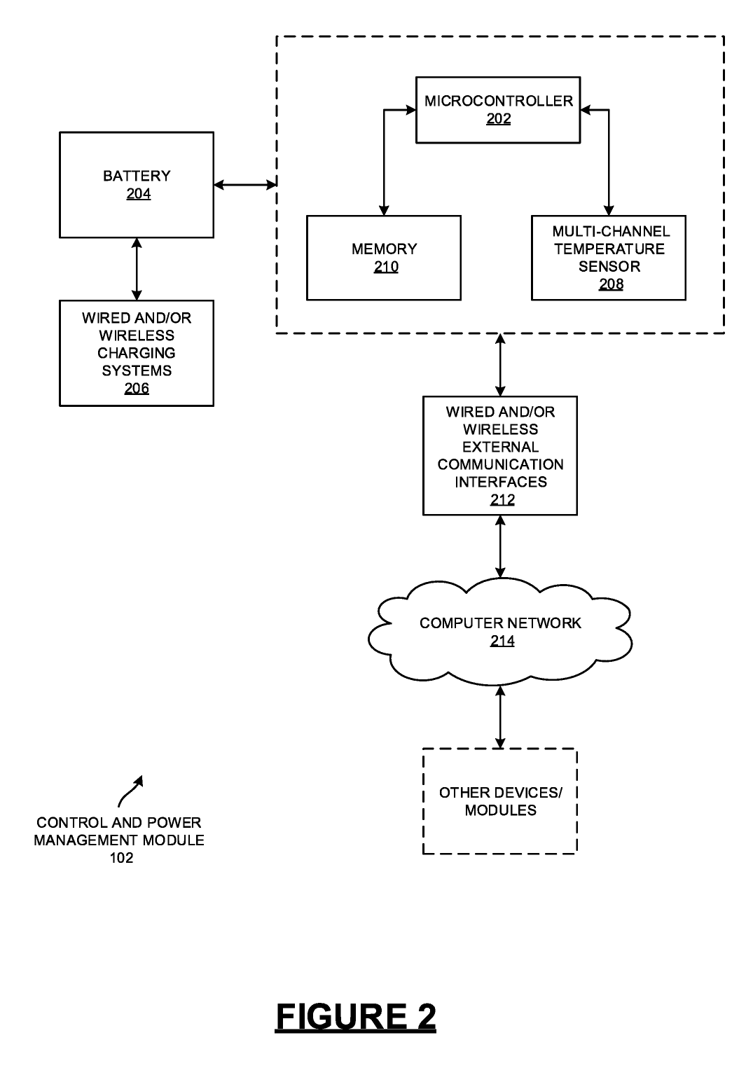

FIG. 2 shows control and power management module 102, according to one or more embodiments. In one or more embodiments, control and power management module 102 may include a microcontroller 202 (e.g., a processor) configured to control the other sensor modules of electrochemical and bioassay sensing platform 100, and to provide pre- and post-data acquisition processing for command/control and data signals, and a battery 204 to generate requisite voltages for components of electrochemical and bioassay sensing platform 100 to enable functioning thereof. In one or more embodiments, control and power management module 102 may also include wired and/or wireless charging systems 206 to transfer and store energy into battery 204 and, in turn, power components of electrochemical and bioassay sensing platform 100, and a multi-channel temperature sensor 208 for thermal measurement, regulation and analyses.

In one or more embodiments, control and power management module 102 may further include a memory 210 communicatively coupled to microcontroller 202 to store commands/instructions to control the other modules of electrochemical and bioassay sensing platform 100 and data input to and/or obtained from the other modules, and wired and/or wireless external communication interfaces 212 to transfer data to and/or from other devices/modules (e.g., through a computer network 214 (e.g., a Wide Area Network (WAN), a Local Area Network (LAN), a short-distance network, Internet)).

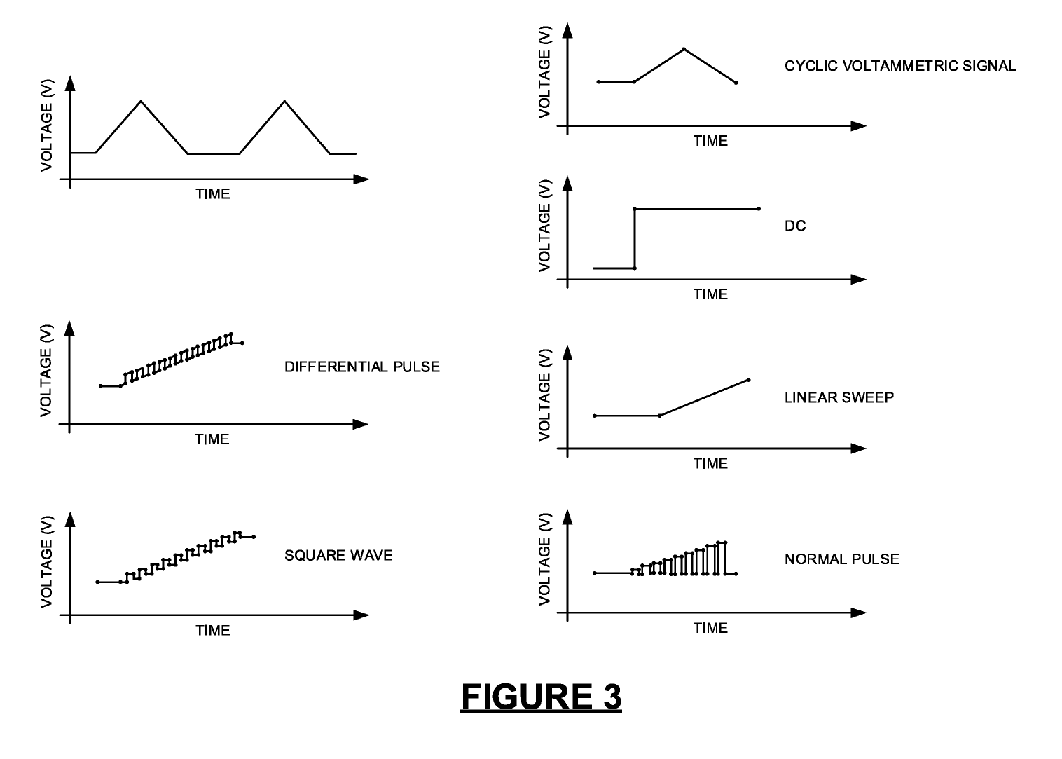

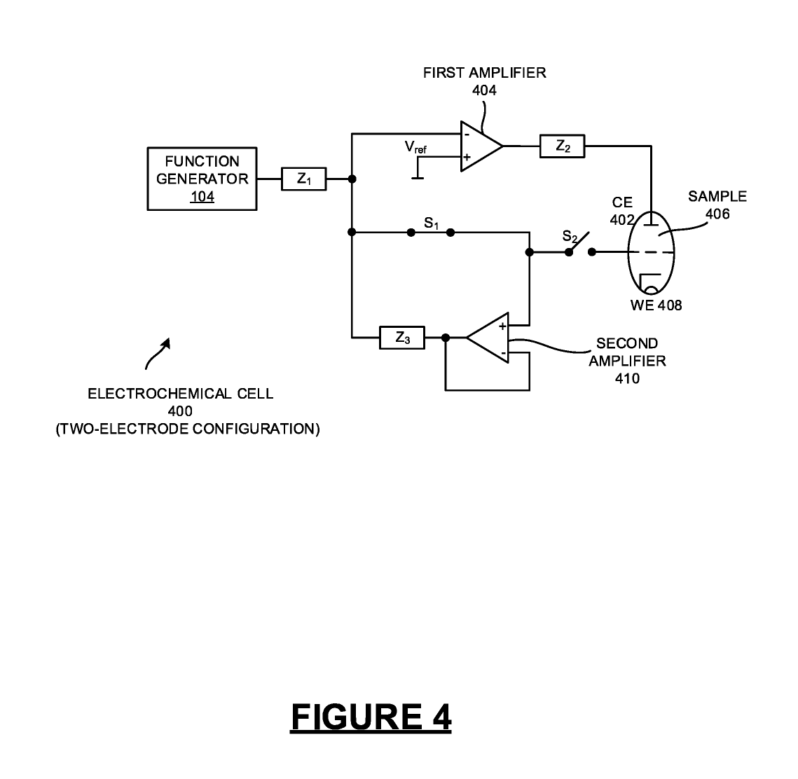

FIG. 3 shows the types of waveforms that can be generated through function generator 104. Function generator 104 (well understood to one skilled in the art) may generate voltammetric waveform patterns based on operation thereof. For the aforementioned purpose, microcontroller 202 may be configured to generate preset waveforms from specified parameters (e.g., stored in memory 210). FIG. 4 shows an example two-electrode configuration of an electrochemical cell 400 formed by solely activating a counter electrode (CE) 402 thereof. Here, function generator 104 may generate a signal that is applied to CE 402 through a first amplifier 404. First amplifier 404 may have the applied signal at an input terminal thereof and a reference voltage (V_{ref}) at another terminal thereof.

Sample 406 (e.g., a chemical, a biological material) may electrolytically contact both CE 402 and a working electrode (WE) 408 to enable an electric current to flow therebetween. In an example implementation, sample 406 may be placed inside a sample chamber (not shown). In the two-electrode configuration, a second amplifier 410 may not be employed; for example, second amplifier 410 may be taken out of the electrical loop based on appropriate utilization of switches S₁ and S₂ (e.g., S₁ CLOSED and S₂ OPEN). FIG. 4 also shows an impedance Z₁ at an input of first amplifier 404 and an impedance Z₂ at an output thereof; Z₃ is at an output of second amplifier 410.

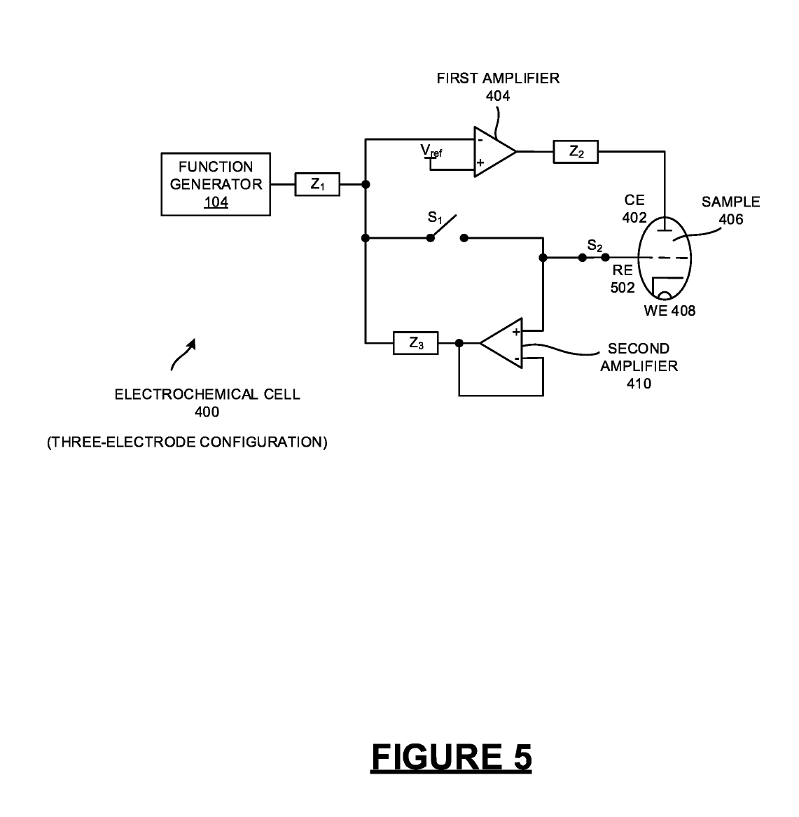

The functioning of electrochemical cell 400 in the two-electrode configuration is well known to one skilled in the art; detailed discussion associated therewith has, therefore, been skipped. FIG. 5 shows a three-electrode configuration of electrochemical cell 400 formed by activating both CE 402 and a reference electrode (RE) 502. RE 502 may set an electrical potential level that serves as a reference for measurement of other electrical potentials. The three-electrode configuration may, again, be realized through the appropriate utilization of switches S₁ and S₂ (e.g., S₁ OPEN and S₂ CLOSED). Again, the three-electrode configuration of electrochemical cell 400 is well known to one skilled in the art; detailed discussion thereof, therefore, has again been skipped.

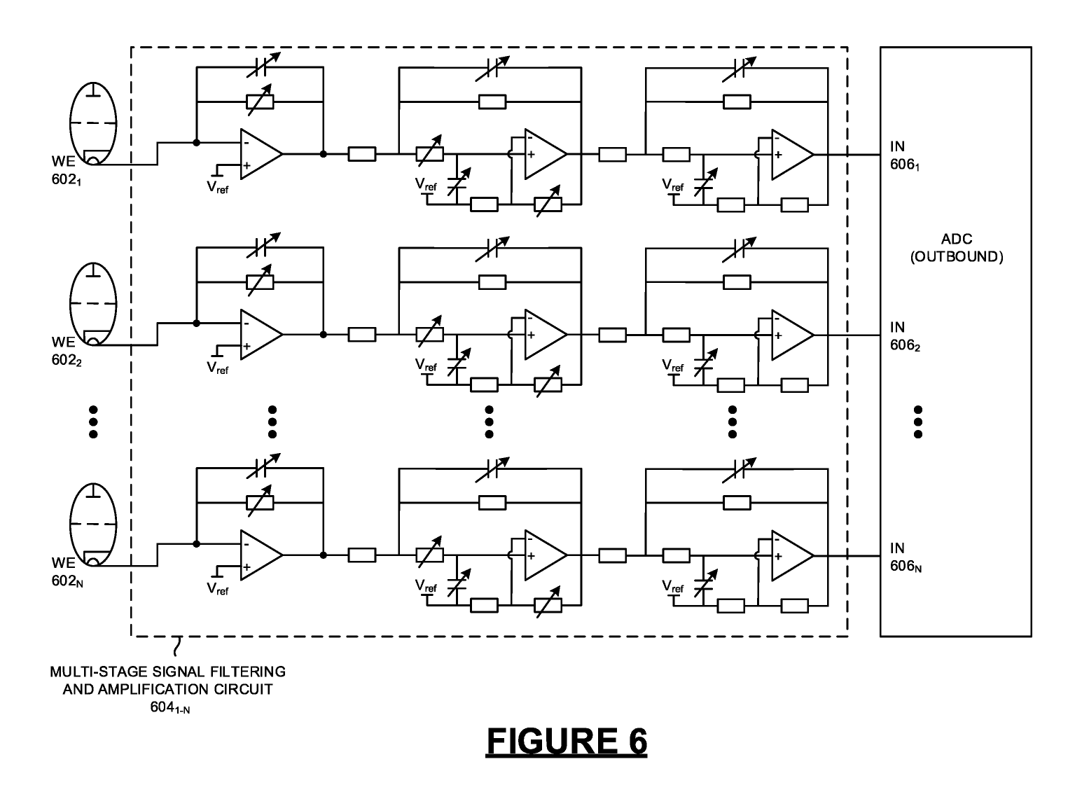

In one or more embodiments, WE 408 may be interfaced with filter(s) and/or Analog-to-Digital (A/D) converters within the system to realize specific signal patterns and/or values of interest. FIG. 6 shows multi-channel amperometric measurement module 106 in the form of a device, according to one or more embodiments. Here, each WE 602_{1-N} (e.g., WE 408) of an electrochemical cell (e.g., electrochemical cell 400) that measures currents between a CE thereof and WE 602_{1-N} may be interfaced with a multi-stage signal filtering and amplification circuit 604_{1-N} for each channel to maintain electrochemical operability and calibrate signals into values of interest through the aid of A/D converters and other relevant circuitry via channel inputs (IN) 606_{1-N}.

FIG. 6 shows an example implementation of multi-stage signal filtering and amplification circuit 604_{1-N}. As the circuitry is known to one skilled in the art, detailed discussion thereof has been skipped. V_{ref} is the reference voltage that may either be directly input to an amplifier of multi-stage signal filtering and amplification circuit 604_{1-N} or reduced in amplitude thereof before being input to the amplifier.

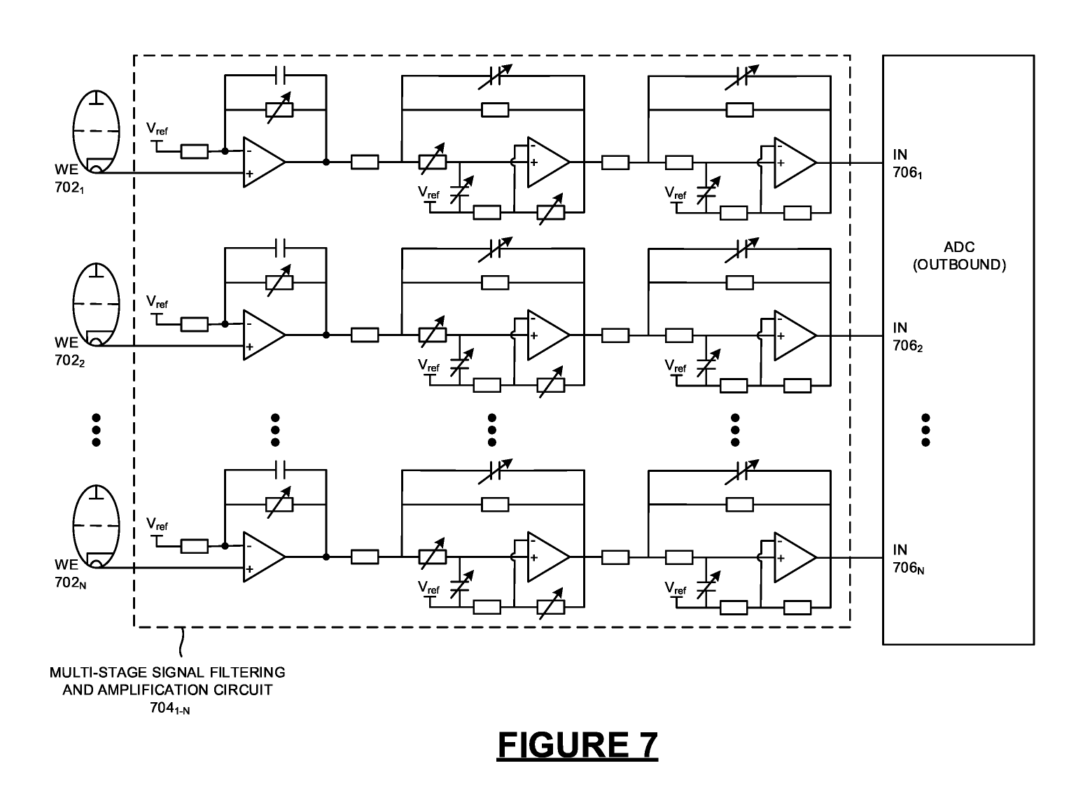

“Channel,” as discussed herein, may refer to a measurement channel, which, in one embodiment, may be related to a distinct signal path related to a frequency or a band of frequencies; “channel” within the context of microfluids may refer to a physical path for fluids. FIG. 7 shows multi-channel potentiometric measurement module 108 in the form of a device, according to one or more embodiments. Here, each WE 702_{1-N} (e.g., WE 408) of an electrochemical cell (e.g., electrochemical cell 400) that measures potential existing across a CE thereof and WE 702_{1-N} may be interfaced with a multi-stage signal filtering and amplification circuit 704_{1-N} for each channel to maintain electrochemical operability and calibrate signals into values of interest through the aid of A/D converters and other relevant circuitry via channel inputs (IN) 706_{1-N}.

FIG. 7 shows an example implementation of multi-stage signal filtering and amplification circuit 704_{1-N}. Again, as the circuitry is known to one skilled in the art, detailed discussion thereof has been skipped. Again, V_{ref} is the reference voltage that may either be directly input to an amplifier of multi-stage signal filtering and amplification circuit 704_{1-N} or reduced in amplitude thereof before being input to the amplifier.

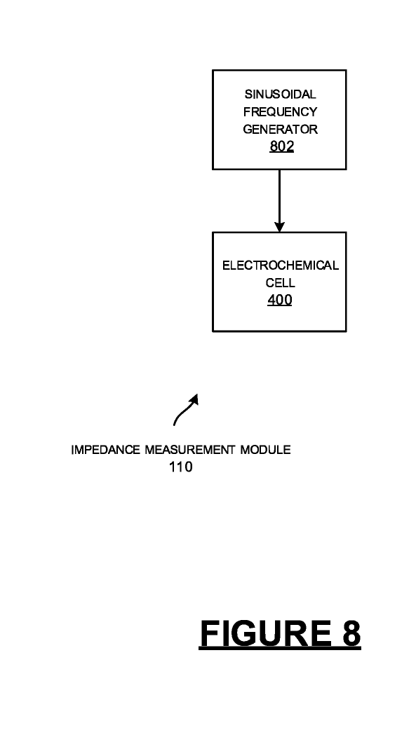

FIG. 8 shows impedance measurement module 110, according to one or more embodiments. In one or more embodiments, impedance measurement module 110 may include a sinusoidal frequency generator 802 configured to generate a signal of known frequency to excite an external complex impedance (e.g., that of sample 406). For the aforementioned purpose, an excitation potential may be applied to electrochemical cell 400, in response to which a current flows therethrough; said current may be phase-shifted with respect to the excitation potential. The complex impedance may be measured by measuring the excited current.

It should be noted that sinusoidal frequency generator 802, in one embodiment, may be the same as function generator 104 and, in another embodiment, different therefrom. In one or more embodiments, electrochemical cell 400 may be interfaced with an analog and digital signal processing circuit 804 to generate intelligible data therefrom.

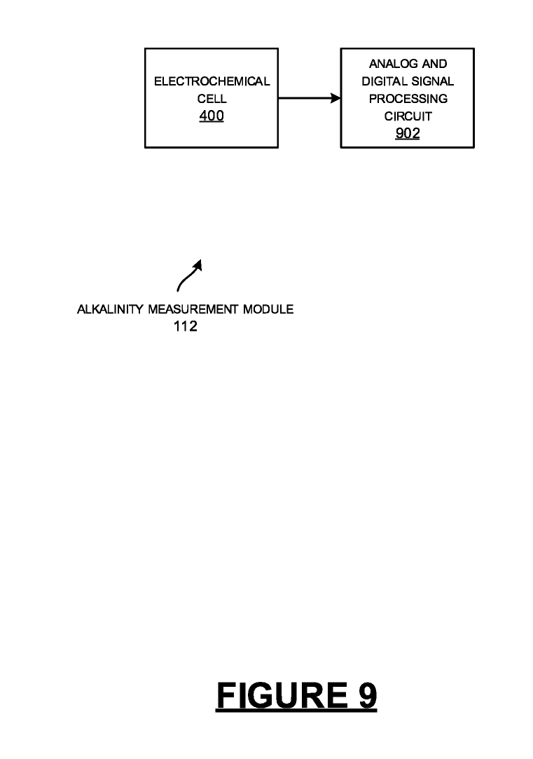

FIG. 9 shows alkalinity measurement module 112, according to one or more embodiments. Here, electrochemical cell 400, for example, may be employed for pH measurement of sample 406 (e.g., in aqueous form). For the aforementioned purpose, a closed circuit may be formed through RE 502 and WE 408. In one example implementation, the potential between WE 408 and RE 502 may be measured; said potential may depend on the pH of sample 406. Again, in one or more embodiments, electrochemical cell 400 may be interfaced with an analog and digital signal processing circuit 902 (e.g., the same as analog and digital signal processing circuit 804) to generate intelligible data therefrom.

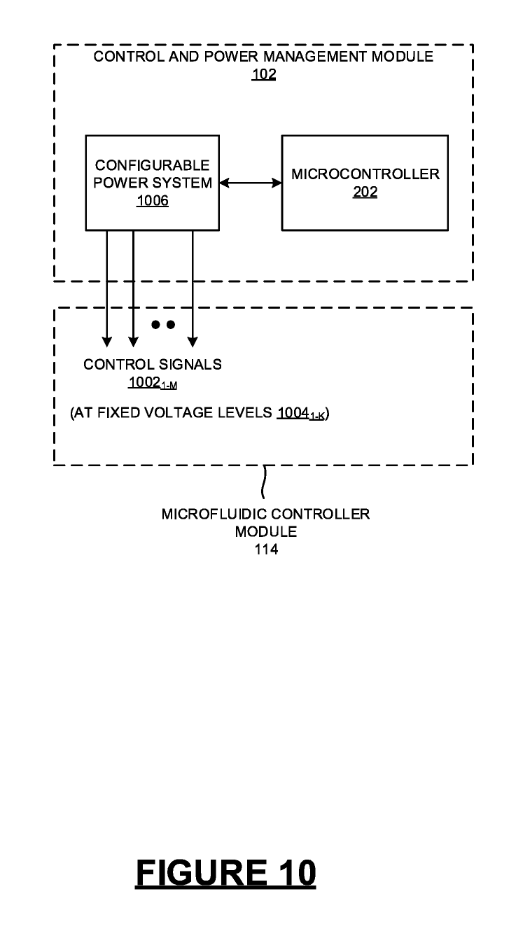

FIG. 10 shows microfluidic controller module 114, according to one or more embodiments. In one or more embodiments, microfluidic controller module 114 may include multiple control signals 1002_{1-M} configured to operate at fixed voltage levels 1004_{1-K} that may be generated through a configurable power system 1006 (e.g., part of control and power management module 102). It should be noted that, in one or more embodiments, microcontroller 202 may control configurable power system 1006 to generate said fixed voltage levels 1004_{1-K}.

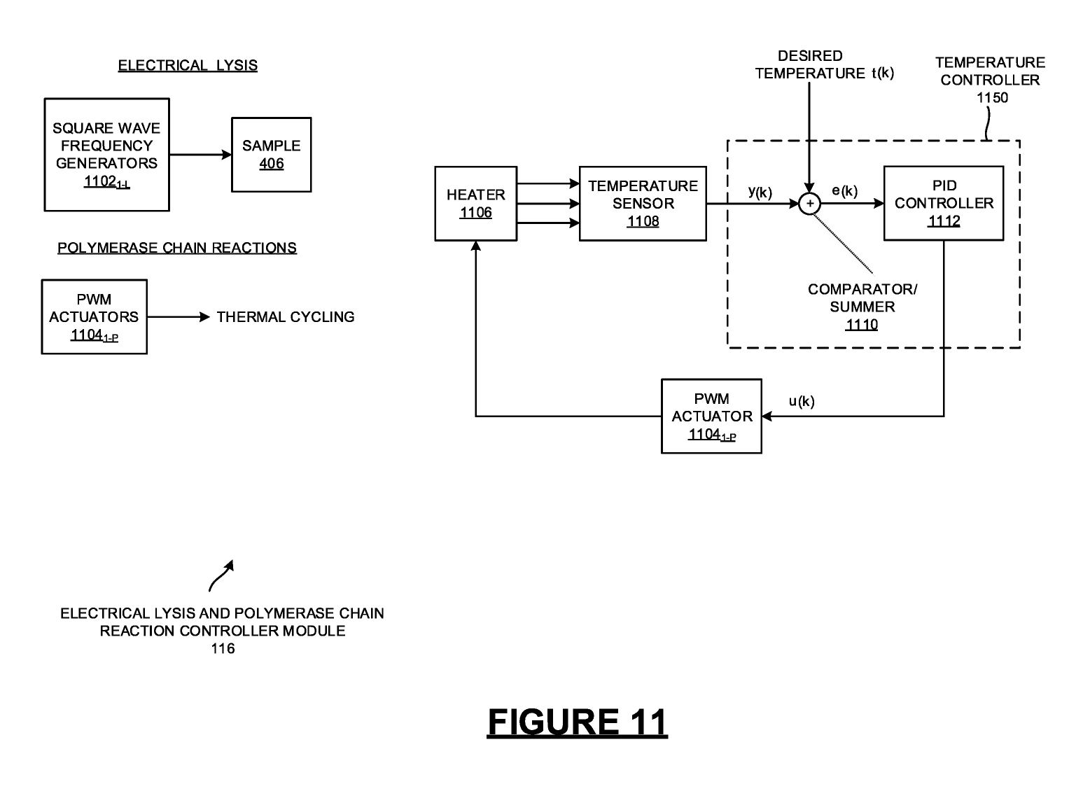

FIG. 11 shows electrical lysis and polymerase chain reaction controller module 116 implemented as a control system, according to one or more embodiments. For electrical lysis, in one or more embodiments, electrical lysis and polymerase chain reaction controller module 116 may include one or more square wave frequency generator(s) 1102_{1-L} (e.g., including function generator 104) configured to generate an electric field high enough to break cell membranes of sample 406 and expose internal cell contents thereof. For polymerase chain reactions, electrical lysis and polymerase chain reaction controller module 116 may include one or more configurable pulse-width modulation (PWM) actuator(s) 1104_{1-P} (e.g., including function generator 104) configured to generate pulse-width modulated square waves capable of sending high voltage and high current signals for thermal cycling.

In FIG. 11, the control system may also include closed-loop control for polymerase chain reaction temperature regulation. FIG. 11 shows a temperature sensor 1108 configured to sense temperature of a heater 1106 employed in the system. The sensed temperature y(k) may be compared (e.g., through a comparator/summer 1110) with a desired temperature t(k) to yield an error signal e(k). Based on e(k), a PID controller 1112 may apply a correction to the control variable, temperature, as u(k), which may control the temperature of heater 1106 through a PWM actuator 1104_{1-P}. PID controller 1112 and comparator/summer 1110 may be part of a temperature controller 1150, in one example embodiment.

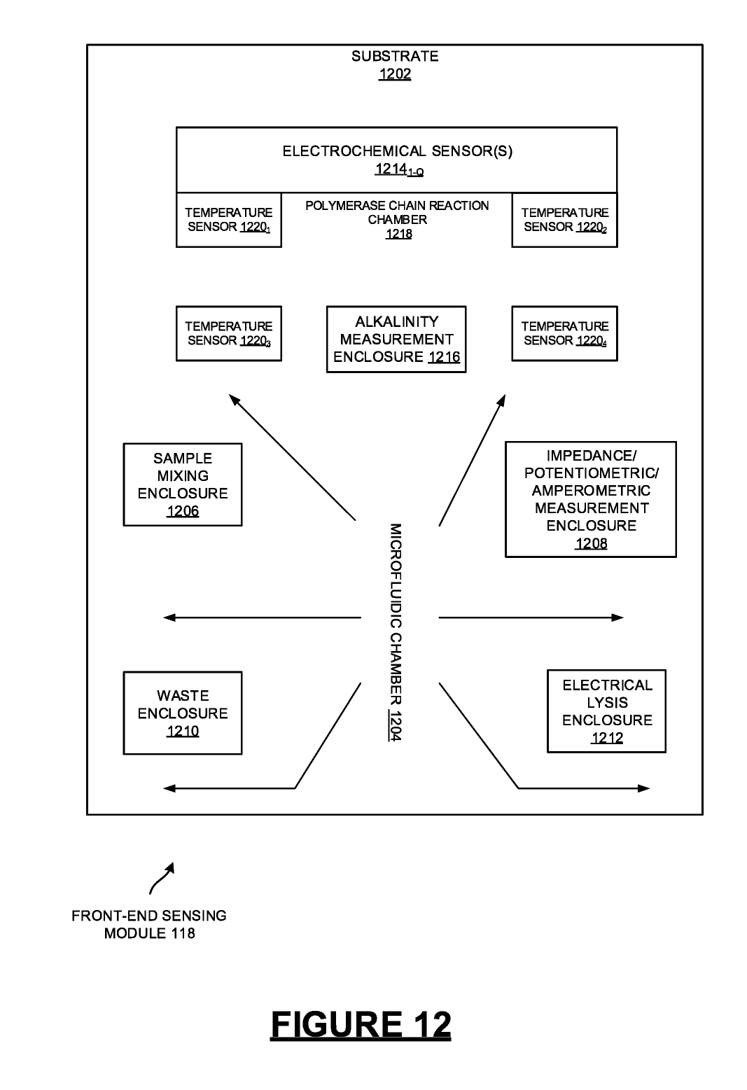

It should be noted that the control system and the temperature sensing discussed with reference to FIG. 11 may be controlled through microcontroller 202 (or, control and power management module 102). FIG. 12 shows front-end sensing module 118 used in conjunction with all other modular components of modular electrochemical and bioassay sensing platform 100, according to one or more embodiments. In one or more embodiments, front-end sensing module 118 may represent real estate available on a substrate 1202. In one or more embodiments, substrate 1202 may include space for a microfluidic chamber 1204 that interfaces with all of a sample mixing enclosure 1206, an impedance/potentiometric/amperometric measurement enclosure 1208, a waste enclosure 1210 for collecting waste associated with sample 406 and an electrical lysis enclosure 1212. In one or more embodiments, microfluidic chamber 1204 may also interface with one or more electrochemical sensor(s) 1214_{1-Q}, an alkalinity measurement enclosure 1216, a polymerase chain reaction chamber 1218 and one or more temperature sensor(s) 1220₁₋₄ (e.g., Resistance Temperature Detector(s) (RTD(s)); FIG. 12 shows four temperature sensor(s) merely for illustrative purposes).

It should be noted that the abovementioned enclosures/chambers may be associated with relevant functionalities such as temperature sensing, impedance/potentiometric/amperometric measurements, electrical lysis (e.g., cell lysis) and polymerase chain reactions. Thus, in one or more embodiments, front-end sensing module 118 may include multiple front-end sensor(s) therefor. Circuitry associated with processing signals to extract desired data may, optionally, also be part of substrate 1202 based on real estate availability thereon. In one or more embodiments, microfluidic chamber 1204 may include multiple micro-valves, micro-pumps and micro-enclosures therein whose parameters (e.g., voltage levels) and opening/closing may be controlled through microcontroller 202.

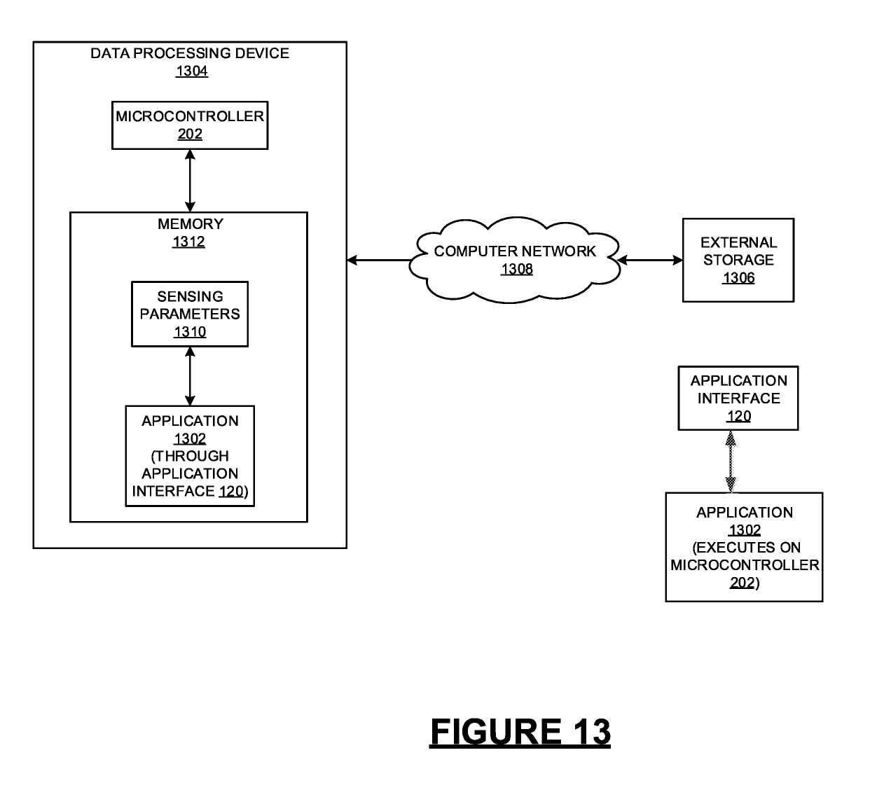

FIG. 13 shows utility of application interface 120 in an example scenario. Here, an application 1302 associated with application interface 120 executing on a data processing device 1304 (a mobile phone, a computer) may enable utilization of data processing device 1304 to move data to and from an external storage 1306. FIG. 13 shows external storage 1306 being communicatively coupled to data processing device 1304 through a computer network 1308 (e.g., computer network 214; external storage 1306 may be cloud storage, in one or more embodiments). In one or more embodiments, application interface 120 may provide sensing parameters 1310 (e.g., stored in a memory 1312 of data processing device 1304) to front-end sensing module 118 and, in turn, may collect data therefrom. In one embodiment, microcontroller 202 may be part of data processing device 1304 and memory 210 may be the same as memory 1312.

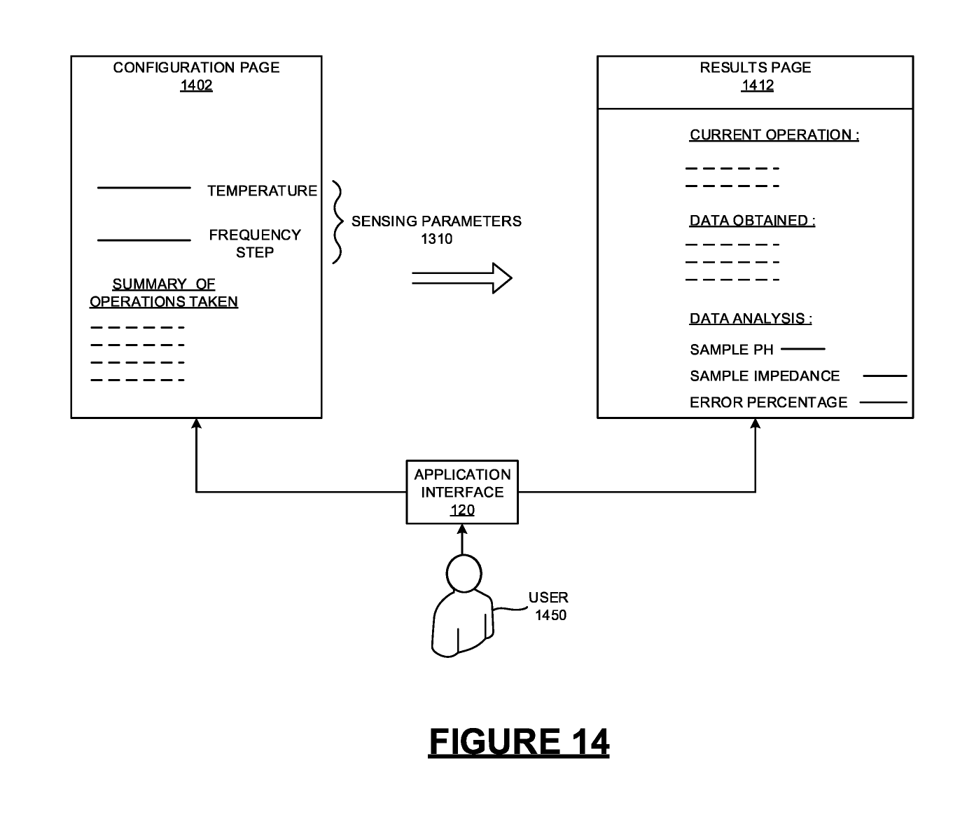

FIG. 14 shows a configuration page 1402 that allows for customizability of sensing parameters 1310 by a user 1450 of application interface 120 and a results page 1412. In one example implementation, configuration page 1402 may display a summary of operations taken for a bioassay for which sensing parameters 1310 are customized. Results page 1412 may display a current operation, data obtained during said current operation and analysis of the obtained data thereof, as shown in FIG. 14.

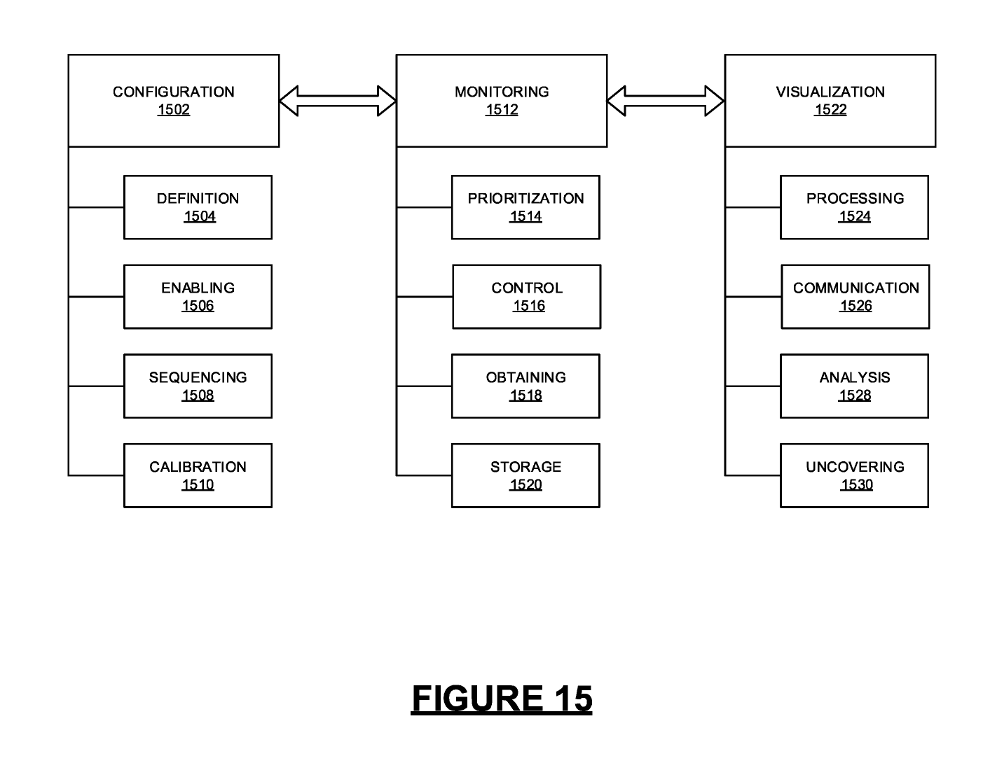

FIG. 15 summarizes stages involved in operating modular electrochemical and bioassay sensing platform 100, according to one or more embodiments. In one or more embodiments, the first stage may involve configuration 1502 where all parameter definitions and sequencing, and calibrations and enabling of modules of modular electrochemical and bioassay sensing platform 100 and/or sub-components thereof are done. FIG. 15 shows configuration 1502 as including definition 1504, enabling 1506, sequencing 1508 and calibration 1510. In one or more embodiments, the second stage may involve monitoring 1512 where prioritization of operations/processes, control of modules/sub-components thereof, obtaining data from modules to be processed and storing said data are done. FIG. 15 shows monitoring 1512 as including prioritization 1514, control 1516, obtaining 1518 and storage 1520.

In one or more embodiments, the third stage may involve visualization 1522 where the stored data is sent to an external module/device for post-acquisition processing and visualization. FIG. 15 shows visualization 1522 as including processing 1524, communication 1526, analysis 1528 and uncovering 1530.

In one or more embodiments, configuration 1502 may be defined through event-triggered operations/processes for the different modules discussed above based on time elapsed. In one or more embodiments, configuration 1502 for function generator 104 may involve controlling generation and amplification of an output control signal for CE 402, and filtering and amplification of an input control signal for RE 502. In one or more embodiments, configuration 1502 for multi-channel amperometric measurement module 106 may involve controlling filtering and amplification of an input current measurement signal for WE 408. In one or more embodiments, configuration 1502 for multi-channel potentiometric measurement module 108 may involve controlling filtering and amplification of an input voltage measurement signal for WE 408.

In one or more embodiments, configuration 1502 for impedance measurement module 110 may involve controlling a frequency band and a frequency step for detecting impedance measurements. In one or more embodiments, configuration 1502 for alkalinity measurement module 112 may involve controlling a sampling rate and a common-mode potential for a front-end sensor (not shown) thereof. In one or more embodiments, configuration 1502 for microfluidic controller module 114 may involve controlling a power system voltage level and a multi-channel output control signal. In one or more embodiments, configuration 1502 for electrical lysis and polymerase chain reaction controller module 116 may involve controlling the one or more square wave frequency generator(s) 1102_{1-L} and the one or more PWM actuator(s) 1104_{1-P}.

In one or more embodiments, monitoring 1512 may, again, be defined through event-triggered operations/processes for different modules/devices based on time elapsed. In one or more embodiments, monitoring 1512 for control and power management module 102 may involve storing temperature data and compilation of stored data. In one or more embodiments, monitoring 1512 for multi-channel amperometric measurement module 106 may involve providing values of interest that are obtained from the input current measurement signal discussed above. In one or more embodiments, monitoring 1512 for multi-channel potentiometric measurement module 108 may involve providing values of interest that are obtained from the input voltage measurement signal discussed above.

In one or more embodiments, monitoring 1512 for impedance measurement module 110 may involve providing values of interest that are obtained through impedance measurements. In one or more embodiments, monitoring 1512 for alkalinity measurement module 112 may involve providing values of interest that are obtained through alkalinity measurements. It is obvious that one or more operations of configuration 1502, monitoring 1512 and visualization 1522 may be controlled, in one embodiment, through microcontroller 202.

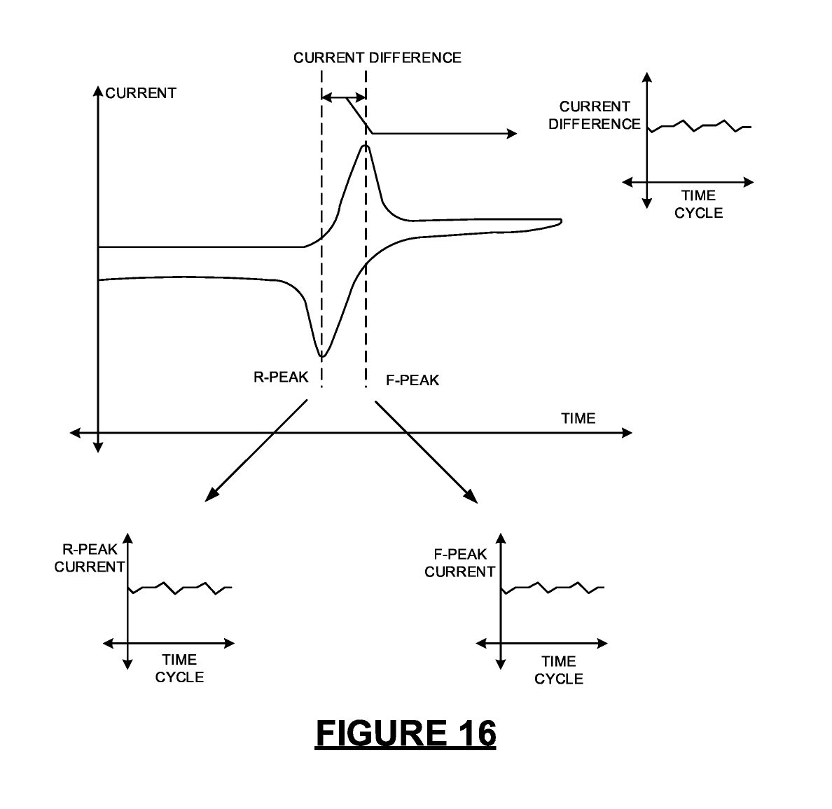

FIG. 16 shows an example visualization of results obtained through utilization of electrochemical cell 400. Here, R-peak current may be a peak value of a reverse electrical current flowing across CE 402 and WE 408, and F-peak current may be a peak value of a forward electrical current flowing thereacross. The aforementioned peak currents as well as the current difference therebetween are plotted in FIG. 16 against a number of time cycles to check for variations between the time cycles. Other post-processing diagrams including input voltage difference between the aforementioned peaks are also possible. In one or more embodiments, visualization 1522 discussed above, again, may be defined through event-triggered operations/processes for the different modules/devices based on time elapsed. In one or more embodiments, visualization 1522 may be associated with numerical and graphical configurable one or more displays (e.g., through data processing device 1304) of post-acquisition and post-processing data.

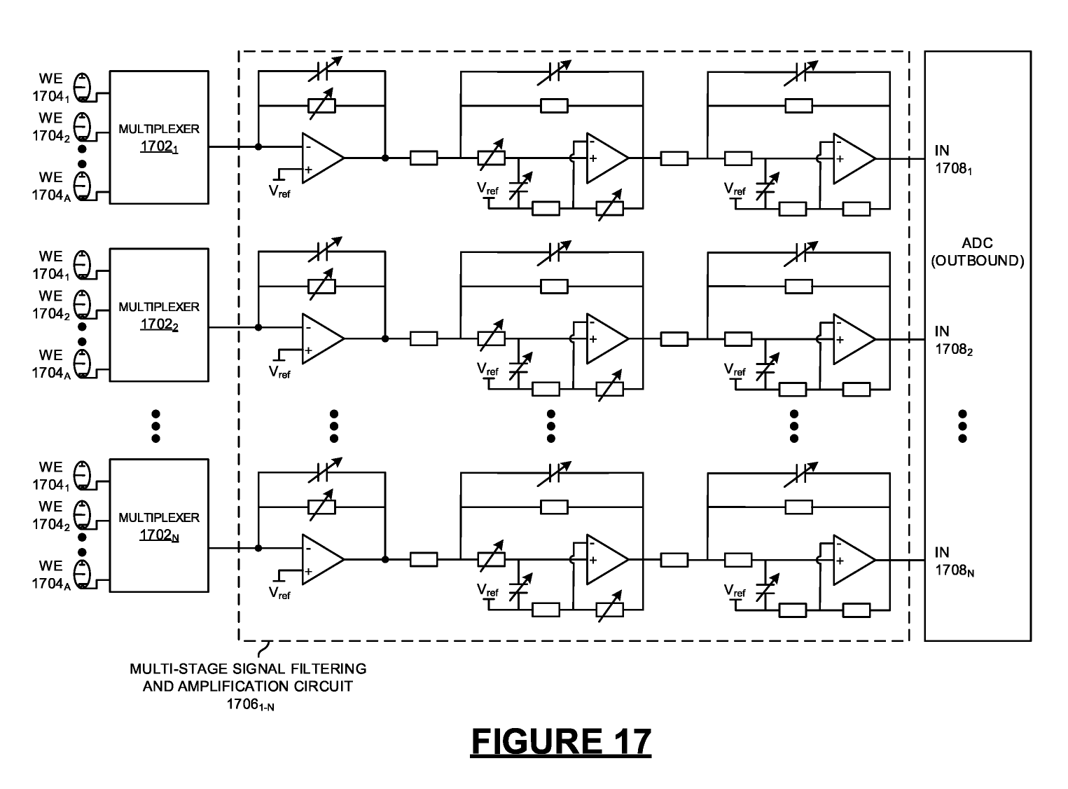

FIG. 17 shows an alternate embodiment of multi-channel amperometric measurement module 106. Here, multi-channel amperometric measurement module 106 may include a number of multiplexers 1702_{1-N}, each of which is coupled between a set of WE(s) 1704_{1-A} (each associated with an electrochemical sensor such as electrochemical sensor 400) and a multi-stage signal filtering and amplification circuit 1706_{1-N}. Again, multi-stage signal filtering and amplification circuit 1706_{1-N} may each be coupled to a corresponding channel input (IN) 1708_{1-N}. The set of multiplexers 1702_{1-N} may provide for an increased number of front-end sensors, thereby expanding measurement capabilities of multi-channel amperometric measurement module 106.

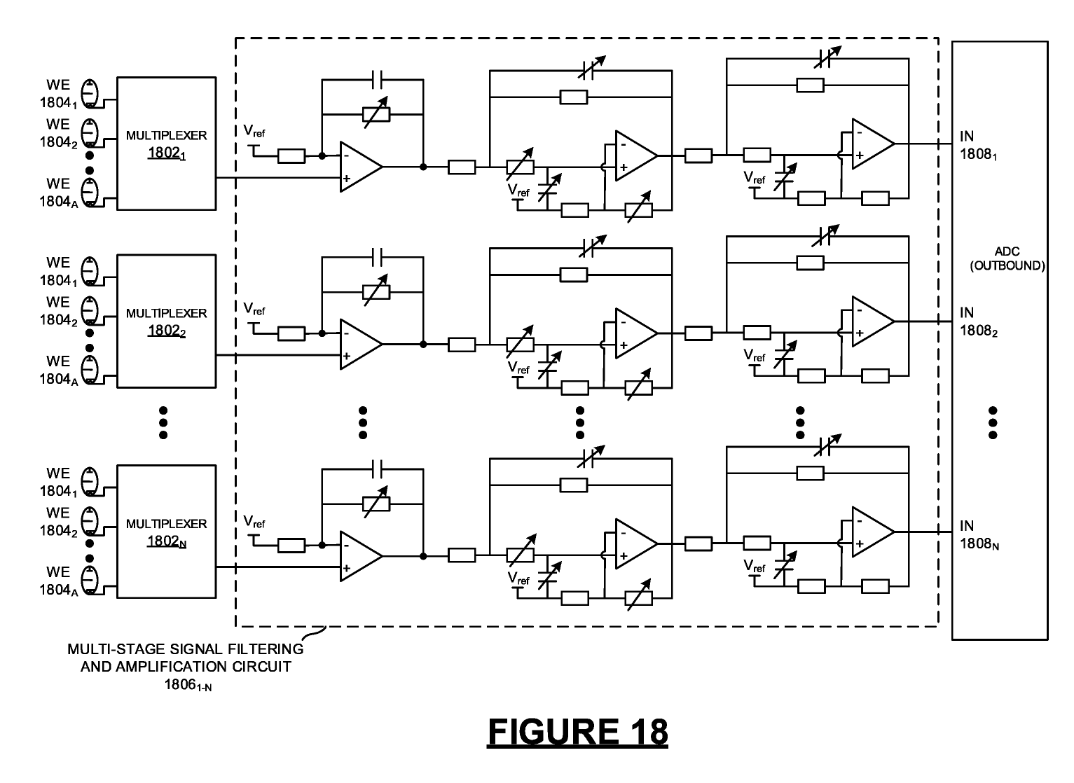

FIG. 18 shows an alternate embodiment of multi-channel potentiometric measurement module 108. Here, again, multi-channel potentiometric measurement module 108 may include a number of multiplexers 1802_{1-N}, each of which is coupled between a set of WE(s) 1804_{1-A} (each associated with an electrochemical sensor such as electrochemical sensor 400) and a multi-stage signal filtering and amplification circuit 1806_{1-N}. Again, multi-stage signal filtering and amplification circuit 1806_{1-N} may each be coupled to a corresponding channel input (IN) 1808_{1-N}. Obviously, the benefits afforded through the set of multiplexers 1802_{1-N} may be the same as those discussed with regard to FIG. 17.

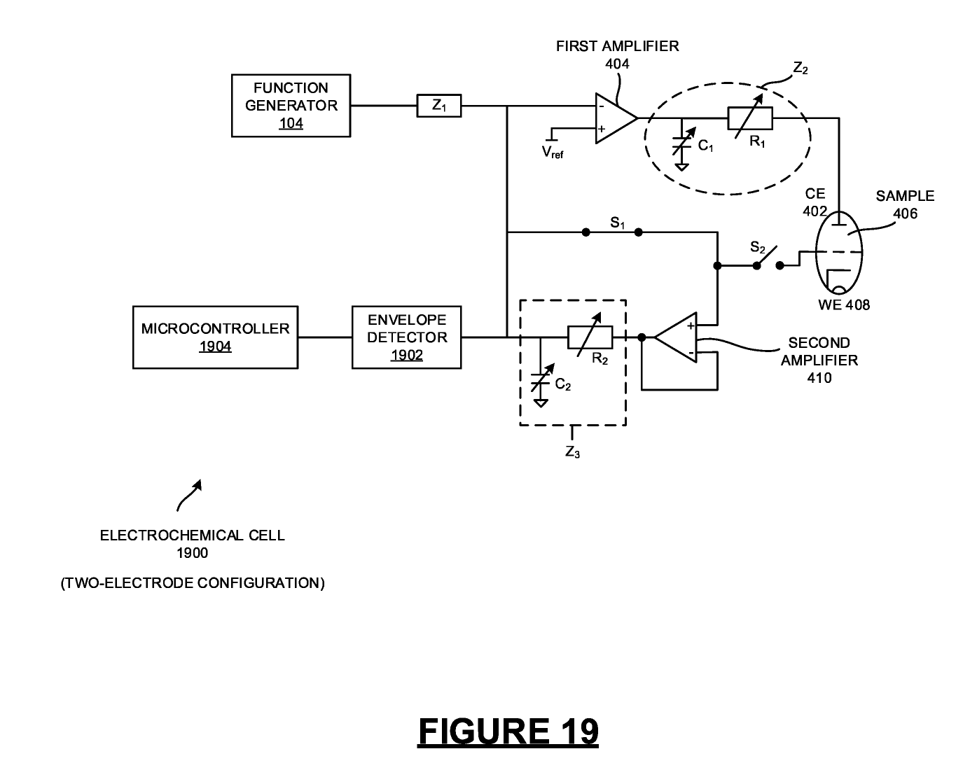

FIG. 19 shows a variation of the two-electrode configuration of electrochemical cell 400 as electrochemical cell 1900. Here, electrochemical cell 1900 may include an envelope detector 1902 to determine the necessary values of variable capacitors (C₁ and C₂) and variable resistors (R₁ and R₂) required for a current test setup. Envelope detector 1902 may be coupled to an output of second amplifier 410 through R₂ and C₂. Envelope detector 1902 may take a signal at a particular frequency and envelope said signal at an output thereof. The output signal of envelope detector 1902 may be sent to a microcontroller 1904 (e.g., microcontroller 202) to automatically determine whether a change in the values of (C₁, C₂) and (R₁, R₂) is required.

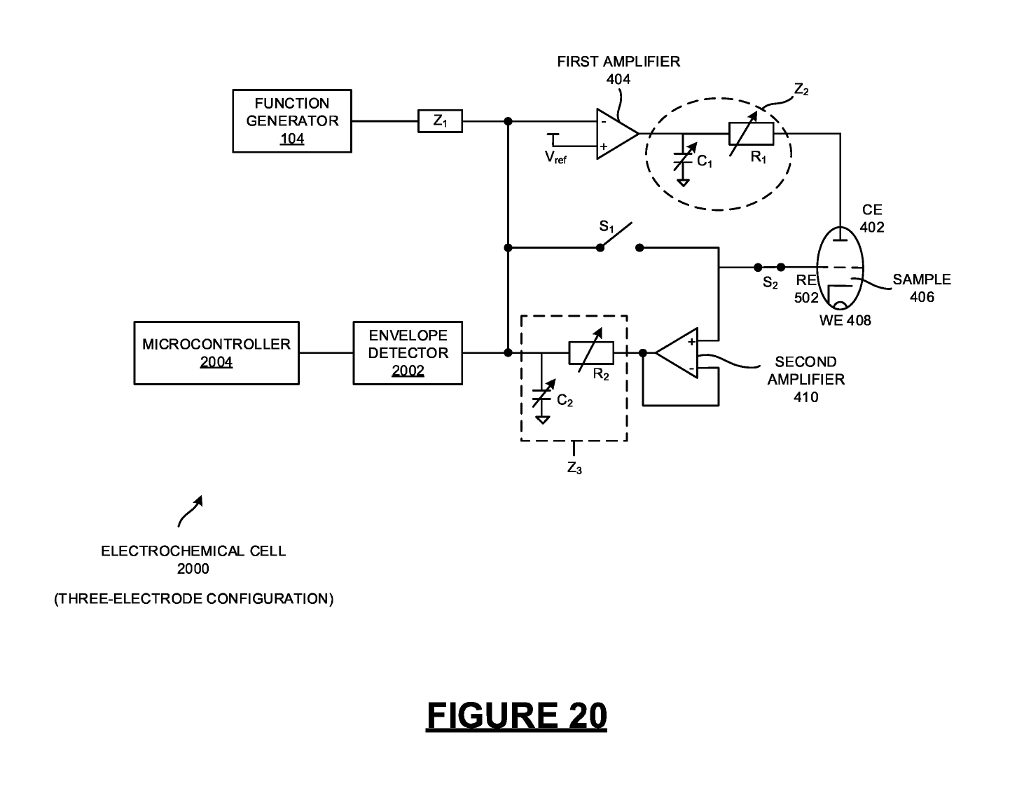

FIG. 20 shows a variation of the three-electrode configuration of electrochemical cell 400 as electrochemical cell 2000. The discussion associated with FIG. 20 is analogous to that associated with FIG. 19.

In traditional solutions, each functional module for the electrochemical/bioassay sensing discussed above may be implemented separately. Digitalization/computer control of said each functional module may also be separate. Also, a sample may be prepared in one operation at a particular place and each experiment thereon conducted at a separate place. This may lead to human error(s) and/or contamination impacting experimental results in the case of traditional solutions being employed. Exemplary embodiments solve the aforementioned problem by providing a one stop front-end sensing module 118 and control thereof through microcontroller 202. Exemplary embodiments may also provide for configuration and monitoring of modules of modular electrochemical and bioassay sensing platform 100, and visualization of data obtained therefrom through application interface 120. In one or more embodiments, the modularization of the platform may enable easy expansion of capabilities thereof and reuse of space/real estate on substrate 1202 of front-end sensing module 118. Thus, front-end sensing module 118 may function as a “lab-on-a-substrate” or a “lab-on-a-chip,” where space is specifically utilized to realize a set of functionalities based on designing components thereon.

It should be noted that nanofluidics/nanofluidic chambers (e.g., including nano-pumps, nano-valves and/or nano-enclosures) are also within the scope of the exemplary embodiments discussed herein. Applicability of the concepts discussed herein extend across future innovations that render fabrication of lab-on-a-chip devices analogous to front-end sensing module 118 based on nanofluidics feasible and/or viable. Also, it should be noted that, depending on the real estate available on substrate 1202, microcontroller 202 may be directly provided on substrate 1202 or be external thereto (e.g., part of data processing device 1304).

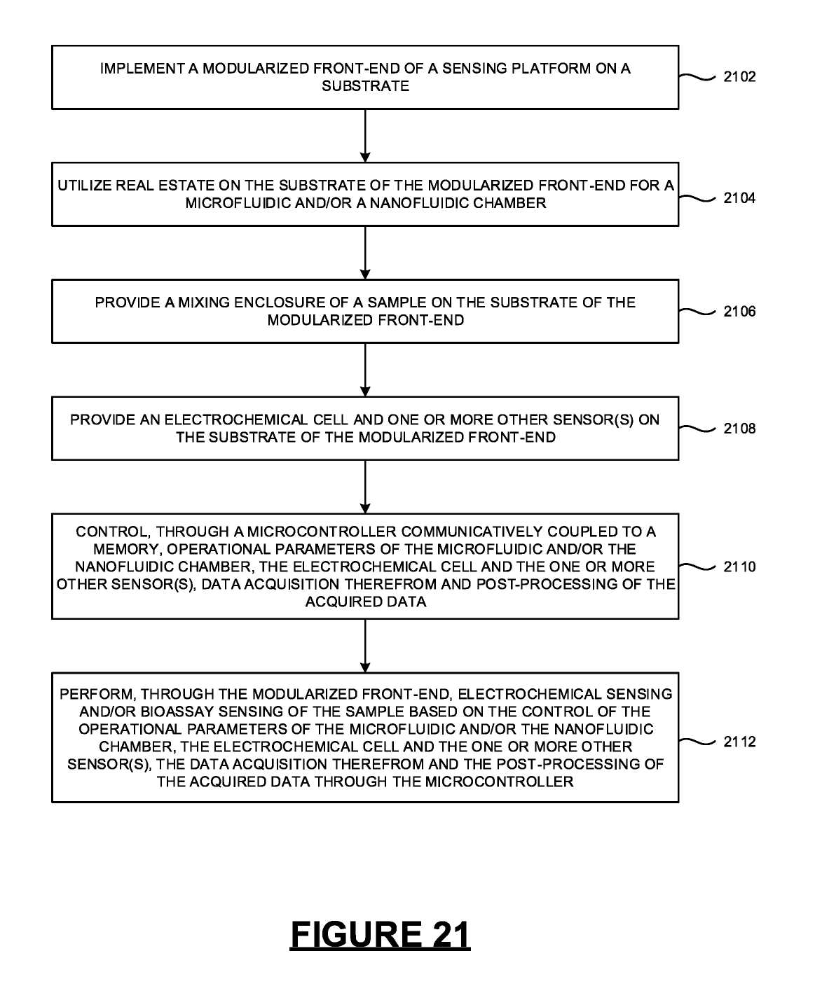

FIG. 21 shows a process flow diagram detailing the operations involved in realizing modular electrochemical and bioassay sensing platform 100, according to one or more embodiments. In one or more embodiments, operation 2102 may involve implementing a modularized front-end (e.g., front-end sensing module 118) of modular electrochemical and bioassay sensing platform 100 on substrate 1202. In one or more embodiments, operation 2104 may involve utilizing real estate on substrate 1202 of the modularized front-end for a microfluidic and/or a nanofluidic chamber (e.g., microfluidic chamber 1204). In one or more embodiments, operation 2106 may involve providing a mixing enclosure (e.g., sample mixing enclosure 1206) of sample 406 on substrate 1202 of the modularized front-end such that the microfluidic and/or the nanofluidic chamber interfaces therewith. In one or more embodiments, sample 406 may include a chemical material and/or a biological material.

In one or more embodiments, operation 2108 may involve providing electrochemical cell 400 and one or more other sensor(s) on substrate 1202 of the modularized front-end such that the microfluidic and/or the nanofluidic chamber interfaces with a corresponding space on substrate 1202 including electrochemical cell 400 and the one or more other sensor(s). In one or more embodiments, the one or more other sensor(s) may be a temperature sensor and/or an alkalinity sensor.

In or more embodiments, operation 2110 may involve controlling, through microcontroller 202 communicatively coupled to memory 210, operational parameters of the microfluidic and/or the nanofluidic chamber, electrochemical cell 400 and the one or more other sensor(s), data acquisition therefrom and post-processing of the acquired data to enable configuration and monitoring of the microfluidic and/or the nanofluidic chamber, electrochemical cell 400 and the one or more other sensor(s) and visualization of the post-processed data. In one or more embodiments, operation 2112 may then involve performing, through the modularized front-end, electrochemical sensing and/or bioassay sensing of the sample based on the control of the operational parameters of the microfluidic and/or the nanofluidic chamber, electrochemical cell 400 and the one or more other sensor(s), the data acquisition therefrom and the post-processing of the acquired data through microcontroller 202.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., data processing device 1304). Accordingly, the specification and drawings are to be regarded in an illustrative rather than a restrictive sense.

What is claimed is:

1. A method of a sensing platform, comprising:
implementing a modularized front-end of the sensing platform on a substrate;
utilizing real estate on the substrate of the modularized front-end for at least one of: a microfluidic and a nanofluidic chamber;
providing a mixing enclosure of a sample on the substrate of the modularized front-end such that the at least one of: the microfluidic and the nanofluidic chamber interfaces therewith, the sample comprising at least one of: a chemical material and a biological material;
providing an electrochemical cell and at least one other sensor on the substrate of the modularized front-end such that the at least one of: the microfluidic and the nanofluidic chamber interfaces with a corresponding:
space on the substrate comprising the electrochemical cell, and
the at least one other sensor, the at least one other sensor being at least one of: a temperature sensor and an alkalinity sensor;
controlling, through a microcontroller communicatively coupled to a memory, operational parameters of the at least one of: the microfluidic and the nanofluidic chamber, the electrochemical cell and the at least one other sensor, data acquisition therefrom and post-processing of the acquired data to enable configuration and monitoring of the at least one of: the microfluidic and the nanofluidic chamber, the electrochemical cell and the at least one other sensor and visualization of the post-processed data; and
performing, through the modularized front-end, at least one of: electrochemical sensing and bioassay sensing of the sample based on the control of the operational parameters of the at least one of: the microfluidic and the nanofluidic chamber, the electrochemical cell and the at least one other sensor, the data acquisition therefrom and the post-processing of the acquired data through the microcontroller.

2. The method of claim 1, further comprising at least one of:
providing a chamber on the substrate of the modularized front-end for performing electrical lysis of the sample such that the chamber interfaces with the at least one of: the microfluidic and the nanofluidic chamber;
providing a polymerase chain reaction enclosure on the substrate of the modularized front-end for performing a polymerase chain reaction associated with the sample such that the polymerase chain reaction enclosure interfaces with the at least one other sensor;
providing an impedance measurement enclosure on the substrate of the modularized front-end for measuring a total opposition of the sample to a flow of alternating current at a given frequency such that the impedance measurement enclosure interfaces with the at least one of: the microfluidic and the nanofluidic chamber;
configuring, through the microcontroller, an input control signal and an output control signal for electrodes of the electrochemical cell;
configuring, through the microcontroller, a frequency generator for the electrical lysis;
configuring, through the microcontroller, a Pulse-Width Modulation (PWM) actuator for the polymerase chain reaction; and
configuring, through the microcontroller, a frequency band and a frequency step for measuring the total opposition of the sample to the flow of the alternating current.

3. The method of claim 1, further comprising performing at least one of: an amperometric measurement and a potentiometric measurement associated with the sample through employing the electrochemical cell in a specific configuration of electrodes thereof.

4. The method of claim 1, comprising providing the microcontroller on one of: the substrate of the modularized front-end and external thereto.

5. The method of claim 3, further comprising:
performing signal filtering and amplification through appropriate circuitry for the at least one of the: amperometric measurement and the potentiometric measurement associated with the sample; and
performing analog and digital signal processing of an output of the alkalinity sensor to generate intelligent data therefrom.

6. The method of claim 1, comprising: loading, through an application interface of the sensing platform, at least one sensing parameter of the operational parameters onto a component of the sensing platform via the microcontroller.

7. The method of claim 1, further comprising effecting, through the microcontroller, control and power management of the sensing platform based on temperature data stored in the memory.

8. A sensing platform comprising:
a modularized front-end implemented on a substrate, the modularized front-end comprising:
at least one of: a microfluidic and a nanofluidic chamber provided on real estate available on the substrate;
a mixing enclosure of a sample provided on the substrate such that the at least one of: the microfluidic and the nanofluidic chamber interfaces therewith, the sample comprising at least one of: a chemical material and a biological material; and
an electrochemical cell and at least one other sensor provided on the substrate such that the at least one of: the microfluidic and the nanofluidic chamber interfaces with a corresponding:
space on the substrate comprising the electrochemical cell, and
the at least one other sensor, the at least one other sensor being at least one of: a temperature sensor and an alkalinity sensor; and
a microcontroller communicatively coupled to a memory, the microcontroller being configured to:
control operational parameters of the at least one of: the microfluidic and the nanofluidic chamber, the electrochemical cell and the at least one other sensor, data acquisition therefrom and post-processing of the acquired data to enable configuration and monitoring of the at least one of: the microfluidic and the nanofluidic chamber, the electrochemical cell and the at least one other sensor and visualization of the post-processed data, and
enable performing, through the modularized front-end, at least one of: electrochemical sensing and bioassay sensing of the sample based on the control of the operational parameters of the at least one of: the microfluidic and the nanofluidic chamber, the electrochemical cell and the at least one other sensor, the data acquisition therefrom and the post-processing of the acquired data.

9. The sensing platform of claim 8,
wherein the modularized front-end further comprises at least one of:
a chamber provided on the substrate for performing electrical lysis of the sample such that the chamber interfaces with the at least one of: the microfluidic and the nanofluidic chamber,
a polymerase chain reaction enclosure provided on the substrate for performing a polymerase chain reaction associated with the sample such that the polymerase chain reaction enclosure interfaces with the at least one other sensor, and
an impedance measurement enclosure provided on the substrate for measuring a total opposition of the sample to a flow of alternating current at a given frequency such that the impedance measurement enclosure interfaces with the at least one of: the microfluidic and the nanofluidic chamber, and
wherein the microcontroller is further configured to at least one of:
configure an input control signal and an output control signal for electrodes of the electrochemical cell,
configure a frequency generator for the electrical lysis,
configure a PWM actuator for the polymerase chain reaction, and
configure a frequency band and a frequency step for measuring the total opposition of the sample to the flow of the alternating current.

10. The sensing platform of claim 8, wherein at least one of: an amperometric measurement and a potentiometric measurement associated with the sample is configured to be performed through employing the electrochemical cell in a specific configuration of electrodes thereof.

11. The sensing platform of claim 8, wherein the microcontroller is provided on one of: the substrate of the modularized front-end and external thereto.

12. The sensing platform of claim 10, further comprising appropriate circuitry to:
perform signal filtering and amplification for the at least one of the: amperometric measurement and the potentiometric measurement associated with the sample, and
perform analog and digital signal processing of an output of the alkalinity sensor to generate intelligent data therefrom.

13. The sensing platform of claim 8, further comprising an application interface to load at least one sensing parameter of the operational parameters onto a component of the sensing platform via the microcontroller.

14. The sensing platform of claim 8, wherein the microcontroller is further configured to effect control and power management of the sensing platform based on temperature data stored in the memory.

15. A sensing platform comprising:
a modularized front-end implemented on a substrate, the modularized front-end comprising:
at least one of: a microfluidic and a nanofluidic chamber provided on real estate available on the substrate,
a mixing enclosure of a sample provided on the substrate such that the at least one of: the microfluidic and the nanofluidic chamber interfaces therewith, the sample comprising at least one of: a chemical material and a biological material, and
an electrochemical cell and at least one other sensor provided on the substrate such that the at least one of: the microfluidic and the nanofluidic chamber interfaces with a corresponding:
space on the substrate comprising the electrochemical cell, and
the at least one other sensor, the at least one other sensor being at least one of: a temperature sensor and an alkalinity sensor; and
a data processing device communicatively coupled to the front-end of the sensing platform, the data processing device being configured to:
control operational parameters of the at least one of: the microfluidic and the nanofluidic chamber, the electrochemical cell and the at least one other sensor, data acquisition therefrom and post-processing of the acquired data to enable configuration and monitoring of the at least one of: the microfluidic and the nanofluidic chamber, the electrochemical cell and the at least one other sensor and visualization of the post-processed data, and
enable performing, through the modularized front-end, at least one of: electrochemical sensing and bioassay sensing of the sample based on the control of the operational parameters of the at least one of: the microfluidic and the nanofluidic chamber, the electrochemical cell and the at least one other sensor, the data acquisition therefrom and the post-processing of the acquired data,
wherein the data processing device executes an application thereon to load at least one sensing parameter of the operational parameters onto a component of the sensing platform.

16. The sensing platform of claim 15,
wherein the modularized front-end further comprises at least one of:
a chamber provided on the substrate for performing electrical lysis of the sample such that the chamber interfaces with the at least one of: the microfluidic and the nanofluidic chamber,
a polymerase chain reaction enclosure provided on the substrate for performing a polymerase chain reaction associated with the sample such that the polymerase chain reaction enclosure interfaces with the at least one other sensor, and
an impedance measurement enclosure provided on the substrate for measuring a total opposition of the sample to a flow of alternating current at a given frequency such that the impedance measurement enclosure interfaces with the at least one of: the microfluidic and the nanofluidic chamber, and
wherein the data processing device is further configured to at least one of:
configure an input control signal and an output control signal for electrodes of the electrochemical cell,
configure a frequency generator for the electrical lysis,
configure a PWM actuator for the polymerase chain reaction, and
configure a frequency band and a frequency step for measuring the total opposition of the sample to the flow of the alternating current.

17. The sensing platform of claim 15, wherein at least one of: an amperometric measurement and a potentiometric measurement associated with the sample is configured to be performed through employing the electrochemical cell in a specific configuration of electrodes thereof.

18. The sensing platform of claim 15, wherein the data processing device is external to the modularized front-end.

19. The sensing platform of claim 17, further comprising appropriate circuitry to:
perform signal filtering and amplification for the at least one of the: amperometric measurement and the potentiometric measurement associated with the sample, and
perform analog and digital signal processing of an output of the alkalinity sensor to generate intelligent data therefrom.

20. The sensing platform of claim 15, wherein the data processing device is further configured to effect control and power management of the sensing platform based on temperature data stored therein.
